(19) United States
(12) Patent Application Publication
(10) Pub. No.: US 2023/0004878 A1
(43) Pub. Date: Jan. 5, 2023

(54) VISIT RESERVATION MANAGEMENT METHOD, VISIT RESERVATION PROCESSING METHOD, AND APPARATUS FOR PERFORMING THE METHODS

(71) Applicant: KAKAO CORP., Jeju-si (KR)

(72) Inventors: Jae Kyoung OH, Seongnam-si (KR); Kyoung Hee NA, Seongnam-si (KR); Jin San SUNG, Seongnam-si (KR)

(21) Appl. No.: 17/853,952

(22) Filed: Jun. 30, 2022

(30) Foreign Application Priority Data
Jun. 30, 2021 (KR) 10-2021-0086122
Jun. 30, 2021 (KR) 10-2021-0086127

(51) Int. Cl. G06Q 10/02; H04L 51/043

(52) U.S. Cl. CPC G06Q 10/02; H04L 51/043

(57) ABSTRACT

Provided are a visit reservation management method, a visit reservation processing method, and an apparatus for performing the methods. A visit reservation management method includes transmitting information about a visit reservation to a visitor terminal and a host terminal through an instant message, and providing notifications such as registration, and change/cancellation of the visit reservation through the instant message, thereby providing convenience of managing the visit reservation. A visit reservation processing method includes providing an instant message including an approval result of check-in to a visitor terminal and a host terminal when the visitor terminal visits a visit place and checks in after a visit reservation is registered, thereby checking the visit of the visitor terminal in real time.

### CROSS-REFERENCE TO RELATED APPLICATIONS

This application claims the benefit of Korean Patent Application No. 10-2021-0086122 filed on Jun. 30, 2021, and Korean Patent Application No. 10-2021-0086127 filed on Jun. 30, 2021 in the Korean Intellectual Property Office, the entire disclosure of which are incorporated herein by reference for all purposes.

### BACKGROUND

### 1. Field of the Invention

One or more example embodiments relate to a visit reservation management method, a visit reservation processing method, and an apparatus for performing the methods, and more particularly, to a process of making a reservation for a visitor through an instant message and a processing process when a visitor terminal receiving information related to the visitor's reservation actually enters a visit place through an instant message.

### 2. Description of the Related Art

Users make an appointment to meet each other in a designated place offline. In this case, when an appointment place is an area related to a specific user (host), it is necessary for a visitor to make a visit reservation in advance to visit the appointment place related to the host.

In this case, it is necessary for the visitor to contact the host by wire to make an appointment to visit, and to contact and notify the host of the visit when the visitor visits a visit place. In addition, even if the visitor arrives at the place where the host works, it is necessary to check whether the visitor has a valid authority to visit the place.

As described above, there is a need for a simpler way to solve the inconvenient procedure for the visitor and host to process the visit reservation and recognize visit.

### SUMMARY

Example embodiments provide a method and apparatus for immediately capable of recognizing registration status of a visit reservation by providing information about the visit reservation to a visitor and a host as an instant message when the visitor makes the visit reservation.

Example embodiments provide a method and apparatus for transmitting an identifier capable of checking whether the visitor has a valid right to enter a visit place when visiting the visit place through the instant message when the visit reservation is in progress.

Example embodiments provide a method and apparatus for transmitting various information to the visitor through the instant message when the visitor visits the visit place after the visit reservation and checks in at the visit place.

Example embodiments provide a method and apparatus for more conveniently performing check-in to the visit place by checking in to the visit place through the instant message received at the time of registering the visit reservation when the visitor enters the visit place of the visit reservation.

Example embodiments provide a method and apparatus for transmitting various information to the visitor through the instant message when the visitor visits the visit place after the visit reservation and checks in at the visit place.

According to an aspect, there is provided a visit reservation management method performed by a visit reservation management server including receiving information about the visit reservation from a host terminal, registering the visit reservation based on the information about the visit reservation received from the host terminal, issuing identification information for a visitor of a visitor terminal recognized by a door system, transmitting a first instant message including information about the visit reservation and the identification information to the visitor terminal using a message server, transmitting a second instant message including information about the visit reservation to the host terminal using the message server, receiving, from the door system, the identification information of the visitor recognized by the door system, checking whether the visitor of the visitor terminal is a visitor registered as the visit reservation by using the identification information of the visitor, transmitting door opening and closing information to the door system when the visitor is the visitor registered as the visit reservation, wherein the first instant message and the second instant message may be transmitted through a chat room of a channel of an institution or business to which a host of the host terminal belongs, a chat room of a channel of the message server, or a chat room of a channel of the visit reservation management server.

The host terminal may have an authority to approve the visit reservation as a registered user pre-approved by the visit reservation management server.

The identification information of the visitor may include contact information of the visitor terminal or an account registered by the visitor terminal in the message server or the visit reservation management server, and the door system may be configured to acquire the identification information of the visitor by recognizing a code displayed in the first instant message.

After a schedule is input to a scheduling application installed in the visitor terminal or the host terminal, the visit reservation corresponding to the schedule set in the scheduling application may be registered, or after the visit reservation is registered in the visit reservation management server, the registered visit reservation may be provided to the scheduling application and the schedule corresponding to the visit reservation may be set in the scheduling application.

According to an aspect, there is provided a visit reservation management method performed by a visit reservation management server including receiving information about the visit reservation from a visitor terminal, transmitting a first instant message requesting approval for the visit reservation of the visitor terminal using the message server, registering the visit reservation based on information about the visit reservation when receiving approval for the visit reservation of the visitor terminal from the host terminal, issuing identification information for a visitor of the visitor terminal recognized by a door system, transmitting a second instant message including information about the visit reservation and the identification information to the visitor terminal using the message server, transmitting a third instant message including information about the visit reservation to the host terminal using the message server, receiving the identification information of the visitor recognized by the door system from the door system, checking whether the visitor of the visitor terminal is a visitor registered as the visit reservation by using the identification information of the visitor, and transmitting door opening and closing information to the door system when the visitor is the visitor registered as the visit reservation, wherein the first instant message, the second instant message, and the third instant message may be transmitted through a chat room of a channel of an institution or business to which a host of the host terminal belongs, a chat room of a channel of the message server, or a chat room of a channel of the visit reservation management server.

The host terminal may have an authority to approve the visit reservation as a registered user pre-approved by the visit reservation management server.

The identification information of the visitor may include contact information of the visitor terminal or an account registered by the visitor terminal in the message server or the visit reservation management server, and the door system may be configured to acquire the identification information of the visitor by recognizing a code displayed in the second instant message.

According to an aspect, there is provided a visit reservation management method performed by a message server including, when the visit reservation is registered in a visit reservation management server, receiving identification information of a visitor and information about the visit reservation from the visit reservation management server, transmitting a first instant message including information about the visit reservation and the identification information of the visitor to a visitor terminal, transmitting a second instant message including information about the visit reservation to a host terminal, and wherein the first instant message and the second instant message may be transmitted through a chat room of a channel of an institution or business to which a host of the host terminal belongs, a chat room of a channel of the message server, or a chat room of a channel of the visit reservation management server.

The host terminal may have an authority to approve the visit reservation as a registered user pre-approved by the visit reservation management server.

The identification information of the visitor may include contact information of the visitor terminal or an account registered by the visitor terminal in the message server or the visit reservation management server, and the door system may be configured to acquire the identification information of the visitor by recognizing a code displayed in the second instant message.

The visit reservation management method may further include transmitting a third instant message including a request for approval for the visit reservation to the host terminal when the information about the visit reservation is input by the visitor terminal, and when the host terminal approves the visit reservation, the visit reservation may be registered in the visit reservation management server.

According to an aspect, there is provided a visit reservation management server including a processor. The processor is configured to receive information about the visit reservation from a host terminal, register the visit reservation based on the information about the visit reservation received from the host terminal, issue identification information for a visitor of the visitor terminal recognized by a door system, transmit a first instant message including information about the visit reservation and the identification information to the visitor terminal using a message server, transmit a second instant message including information about the visit reservation to the host terminal using the message server, receive the identification information of the visitor recognized by the door system from the door system, check whether the visitor of the visitor terminal is a visitor registered as the visit reservation by using the identification information of the visitor, transmit door opening and closing information to the door system when the visitor is the visitor registered as the visit reservation, and wherein the first instant message and the second instant message may be transmitted through a chat room of a channel of an institution or business to which a host of the host terminal belongs, a chat room of a channel of the message server, or a chat room of a channel of the visit reservation management server.

According to an aspect, there is provided a visit reservation management server including a processor. The processor is configured to receive information about the visit reservation from a visitor terminal, transmit a first instant message requesting approval for the visit reservation of the visitor terminal using the message server, register the visit reservation based on information about the visit reservation when receiving approval for the visit reservation of the visitor terminal from the host terminal, issue identification information for a visitor of the visitor terminal recognized by a door system, transmit a second instant message including information about the visit reservation and the identification information to the visitor terminal using a message server, transmit a third instant message including information about the visit reservation to the host terminal using the message server, receive the identification information of the visitor recognized by the door system from the door system, check whether the visitor of the visitor terminal is a visitor registered as the visit reservation by using the identification information of the visitor, transmit door opening and closing information to the door system when the visitor is the visitor registered as the visit reservation, and wherein the first instant message, the second instant message, and the third instant message may be transmitted through a chat room of a channel of an institution or business to which a host of the host terminal belongs, a chat room of a channel of the message server, or a chat room of a channel of the visit reservation management server.

According to an aspect, there is provided a message server including a processor. The processor is configured to when the visit reservation is registered in a visit reservation management server, receive identification information of a visitor and information about the visit reservation from the visit reservation management server, transmit a first instant message including information about the visit reservation and the identification information of the visitor to a visitor terminal, transmit a second instant message including information about the visit reservation to a host terminal, and wherein the first instant message and the second instant message may be transmitted through a chat room of a channel of an institution or business to which a host of the host terminal belongs, a chat room of a channel of the message server, or a chat room of a channel of the visit reservation management server.

According to an aspect, there is provided a visit reservation processing method performed by a visit reservation management server including transmitting a first instant message including information about the visit reservation and identification information of a visitor to a visitor terminal using a message server after the visit reservation is registered, transmitting a second instant message for reminding the visit reservation to the visitor terminal using the message server until before a visit time set in the visit reservation, receiving the identification information of the visitor recognized by a door system from the door system, checking whether the visitor of the visitor terminal is a visitor registered as the visit reservation by using the identification information of the visitor, transmitting door opening and closing information to the door system when the visitor is the visitor registered as the visit reservation, and transmitting a third instant message including result information about check-in of the visitor terminal for checking whether the visitor of the visitor terminal is a visitor registered as the visit reservation using the message server to the visitor terminal, and the first instant message, the second instant message, and the third instant message may be transmitted to the visitor terminal through a chat room of a channel of an institution or business to which a host of the host terminal belongs, or a chat room of a channel of the visit reservation management server.

The visit reservation processing method may further include transmitting a fourth instant message for notifying an end of the visit reservation to the visitor terminal using the message server before an end time set in the visit reservation.

The visit reservation management server may be configured to provide an application service related to a visit place set in the visit reservation to the visitor terminal through the first instant message, the second instant message, or the third instant message.

The application service is provided through an application server connected to the visit reservation management server, and may include at least one of (i) a service for registering a vehicle of the visitor at the visit place, (ii) a service for providing an introduction of an institution or business related to the visit place, (iii) a service providing information about an item sold at the visit place and allowing to order the item, (iv) a service processing cost settlement to get out of the vehicle of the visitor registered before an end point in time set in the visit reservation, or (v) a service providing promotional content of the institution or business related to the visit place.

The third instant message may include content to be reminded that is different according to a time interval with the visit time included in the visit reservation.

The visit reservation processing method may further include providing an interface accessible content to be shared between the visitor of the visitor terminal and the host of the host terminal before or after a visit end time included in the visit reservation.

The content may be stored in a storage space set in the visit reservation management server for each of the visit reservation.

The visit reservation processing method may further include providing an interface capable of checking an instant message for a notification of the visit reservation, the reminder of the visit reservation, a result of check-in at the visit place, or a notification of an end time of the visit reservation transmitted through the chat room.

According to an aspect, there is provided a visit reservation management server including a processor. The processor is configured to transmit a first instant message including information about the visit reservation and identification information of a visitor to a visitor terminal using a message server after the visit reservation is registered, transmit a second instant message for reminding the visit reservation to the visitor terminal using the message server until before a visit time set in the visit reservation, receive the identification information of the visitor recognized by a door system from the door system, check whether the visitor of the visitor terminal is a visitor registered as the visit reservation by using the identification information of the visitor, transmit door opening and closing information to the door system when the visitor is the visitor registered as the visit reservation, and transmit a third instant message including result information about check-in of the visitor terminal for checking whether the visitor of the visitor terminal is a visitor registered as the visit reservation using the message server to the visitor terminal, and the first instant message, the second instant message, and the third instant message may be transmitted to the visitor terminal through a chat room of a channel of an institution or business to which a host of the host terminal belongs, or a chat room of a channel of the visit reservation management server.

Additional aspects of example embodiments will be set forth in part in the description which follows and, in part, will be apparent from the description, or may be learned by practice of the disclosure.

According to example embodiments, it is possible to immediately recognize the registration status of a visit reservation by providing information about the visit reservation to a visitor and a host as an instant message when the visitor makes the visit reservation.

According to example embodiments, it is possible to transmit an identifier capable of checking whether the visitor has a valid right to enter a visit place when visiting the visit place through the instant message when the visit reservation is in progress.

According to example embodiments, it is possible to transmit various information to the visitor through the instant message when the visitor visits the visit place after the visit reservation and checks in at the visit place.

According to example embodiments, it is possible to perform check-in to the visit place more conveniently by checking in to the visit place through the instant message received at the time of registering the visit reservation when the visitor enters the visit place of the visit reservation.

According to example embodiments, it is possible to transmit various information to the visitor through the instant message when the visitor visits the visit place after the visit reservation and checks in at the visit place.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating apparatuses for performing a visit reservation management method and/or a visit reservation processing method according to an example embodiment;

FIG. 2 is a flowchart illustrating a visit reservation management method when a host terminal makes a visit reservation according to an example embodiment;

FIG. 3 is a flowchart illustrating a visit reservation management method when a visitor terminal makes a visit reservation according to an example embodiment;

FIG. 4 is a diagram illustrating an example of a visit reservation registration page according to an example embodiment;

FIG. 5 is a diagram illustrating an example of an instant message for a host terminal to approve a visit reservation when a visitor terminal makes the visit reservation according to an example embodiment;

FIG. 6 is a diagram illustrating an example of a visit reservation management page according to an example embodiment;

FIG. 7 is a diagram illustrating an example of instant messages provided to a visitor terminal and a host terminal after a visit reservation is registered according to an example embodiment;

FIG. 8 is a diagram illustrating an example of instant messages provided to a visitor terminal and a host terminal before and at the time the visitor terminal arrives at a visit place after a visit reservation, and after the visitor terminal checks in according to an example embodiment;

FIG. 9 is a diagram illustrating instant messages provided to a visitor terminal before and after check-in at a visit place according to an example embodiment; and

FIG. 10 is a diagram illustrating a visit reservation processing method according to an example embodiment.

### DETAILED DESCRIPTION

Hereinafter, example embodiments will be described in detail with reference to the accompanying drawings. However, it should be understood that these example embodiments are not construed as limited to the illustrated forms. Like reference numerals in each figure refer to like components.

Various modifications may be made to the example embodiments below. Here, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

The terminology used herein is for the purpose of describing particular example embodiments only and is not to be limiting of the example embodiments. The singular forms are intended to include the plural forms as well, unless the context clearly indicates otherwise. It will be further understood that the terms “comprises” and/or “comprising,” when used in this specification, specify the presence of statusd features, integers, operations, operations, elements, components or a combination thereof, but do not preclude the presence or addition of one or more other features, integers, operations, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

When describing the example embodiments with reference to the accompanying drawings, like reference numerals refer to like components and a repeated description related thereto will be omitted. When those skilled in the art determines that a known function related to the present disclosure is self-evident and may unnecessarily obscure the gist of the present disclosure, detailed descriptions thereof are omitted.

Hereinafter, example embodiments will be described in detail with reference to the accompanying drawings.

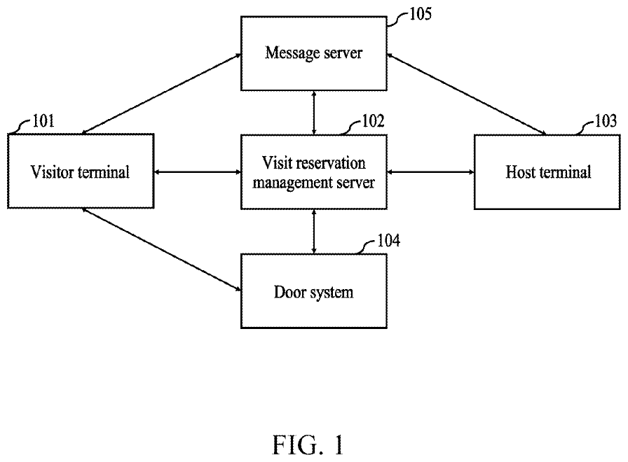

FIG. 1 is a diagram illustrating apparatuses for performing a visit reservation management method and/or a visit reservation processing method according to an example embodiment.

Referring to FIG. 1, a visitor terminal 101, a visit reservation management server 102, a host terminal 103, a door system 104, and a message server 105 are illustrated. The host terminal 103 may register a visit reservation for a visitor of the visitor terminal 101 by inputting a visit time and a visit place through a visit reservation management page provided by the visit reservation management server 102. In addition to the host terminal 103, the visitor terminal 101 may also register such a visit reservation. When registering the visit reservation, the visitor's name, the visit time, and the visit place (e.g., conference room) and contact information of the visitor terminal may be input to the visit reservation management page.

In this case, a host of the host terminal 103 may be a pre-registered user approved by the visit reservation management server 102. Further, the host of the host terminal 103 may be a user belonging to an institution or business related to the visit place (e.g., employees).

The host may be a user having the authority to approve a visit reservation when the visitor of the visitor terminal 101 wants to visit the visit place. Therefore, when the host terminal 103 registers the visit reservation, a separate approval process for the visit reservation may not be required. However, when the visitor terminal 101 registers the visit reservation, a process for the host terminal 103 to approve the visit reservation may be required.

When the visit reservation is registered, the visit reservation management server 102 may generate identification information of the visitor related to the visit reservation after registering the visit reservation. Here, the identification information of the visitor may include contact information of the visitor or an account of the visitor related to the visit reservation management server 102 or the message server 105.

The visit reservation management server 102 may transmit information about the visit reservation and the identification information of the visitor to the message server 105. Then, the message server 105 may transmit a first instant message including information about the visit reservation and/or the identification information of the visitor to the visitor terminal 101. For example, the identification information of the visitor is displayed as a code in the first instant message, and the door system 104 may acquire the identification information of the visitor from the visitor terminal 101 by recognizing the code. Further, the message server 105 may transmit a second instant message including information about the visit reservation and the identification information of the visitor to the host terminal 103.

The message server 105 may transmit the first instant message to the visitor terminal 101 through a chat room of a channel of an institution or business to which the host of the host terminal 103 belongs, or a chat room of a channel of the visit reservation management server 102. Likewise, the message server 105 may transmit the second instant message to the host terminal 103 through a chat room of a channel of an institution or business to which the host of the host terminal 103 belongs, or a chat room of a channel of the visit reservation management server 102.

In this case, the visitor terminal 101 and the host terminal 103 may have accounts by subscribing to a message service provided by the message server 105. In addition, the account of the visitor terminal 101 may be mapped with the contact information of the visitor terminal 101, and the account of the host terminal 103 may be mapped with the contact information of the host terminal 103.

The first instant message transmitted to the visitor terminal 101 after the visit reservation is registered may include information about the visit reservation and the identification information of the visitor. Here, the identification information of the visitor included in the first instant message may be used to recognize the visitor terminal 101 to the door system 104 to determine whether the visitor of the visitor terminal 101 may pass through the door system 104. As an example, the first instant message transmitted to the visitor terminal 101 may include the identification information (e.g., QR code) of the visitor for recognizing the visitor terminal 101 to the door system 104 of the visit place.

The door system 104 (e.g., an access gate) disposed at the visit place may recognize the visitor terminal 101 to acquire the identification information of the visitor included in the first instant message.

As described above, the identification information may be included in the first instant message received from the message server 105 after the visit reservation for the visitor terminal 101 is registered. The visit reservation management server 102 may determine whether the visitor of the visitor terminal 101 recognized by the door system 104 through the identification information of the visitor is a visitor registered for the visit reservation. In other words, the visit reservation management server 102 may determine whether the visitor of the visitor terminal 101 recognized by the door system 104 has a valid right to visit the visit place through the identification information of the visitor.

The visit reservation management server 102 may transmit door opening/closing information to the door system 104 after checking whether the visitor is a registered user for the visit reservation using the identification information of the visitor received from the door system 104. When the visitor of the visitor terminal 101 recognized by the door system 104 is a visitor registered for the visit reservation, the visit reservation management server 102 may transmit information notifying to open the door to the door system 104.

Specifically, the door system 104 may recognize the visitor terminal 101 to acquire the identification information of the visitor included in the first instant message received by the visitor terminal 101. Then, the visit reservation management server 102 compares the contact information of the visitor terminal 101 registered through the visit reservation management page with the contact information of the visitor terminal 101 recognized the identification information acquired from the door system 104, thereby determining whether the visitor of the visitor terminal 101 has a valid right to visit the visit place. As described above, the process of determining whether the visitor of the visitor terminal 101 is a visitor registered as the visit reservation based on the identification information after recognizing the visitor terminal 101 to acquire the identification information of the visitor is a check-in process of the visitor terminal 101.

According to an example embodiment, after the visit reservation of the visitor terminal 101 is registered, the third instant message related to a reminder of the visit reservation may be transmitted to the visitor terminal 101 through the message server 105 before the visitor terminal 101 checks in to the visit place.

According to an example embodiment, when the visitor terminal 101 successfully checks in to the visit place, the visitor of the visitor terminal 101 may enter the visit place. Then, the visit reservation management server 102 may deliver the result information about check-in to the message server 105 to notify the result of the check-in of the visitor terminal 101. The message server 105 may transmit a fourth instant message including the result information about the check-in of the visitor terminal 101 to the visitor terminal 101. Further, the message server 105 may transmit a fifth instant message including the result information about the check-in of the visitor terminal 101 to the host terminal 103.

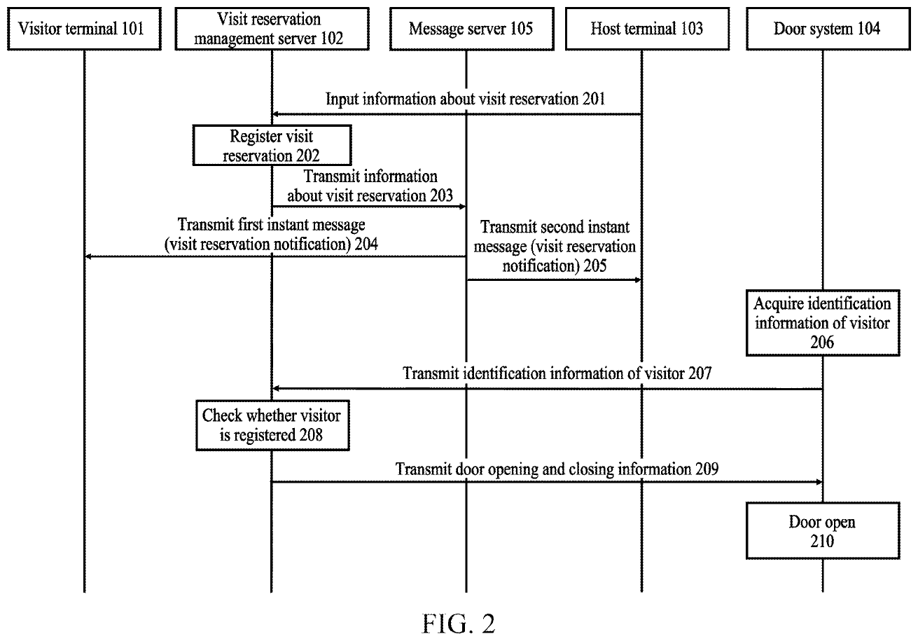

FIG. 2 is a flowchart illustrating a visit reservation management method of when the host terminal makes the visit reservation according to an example embodiment.

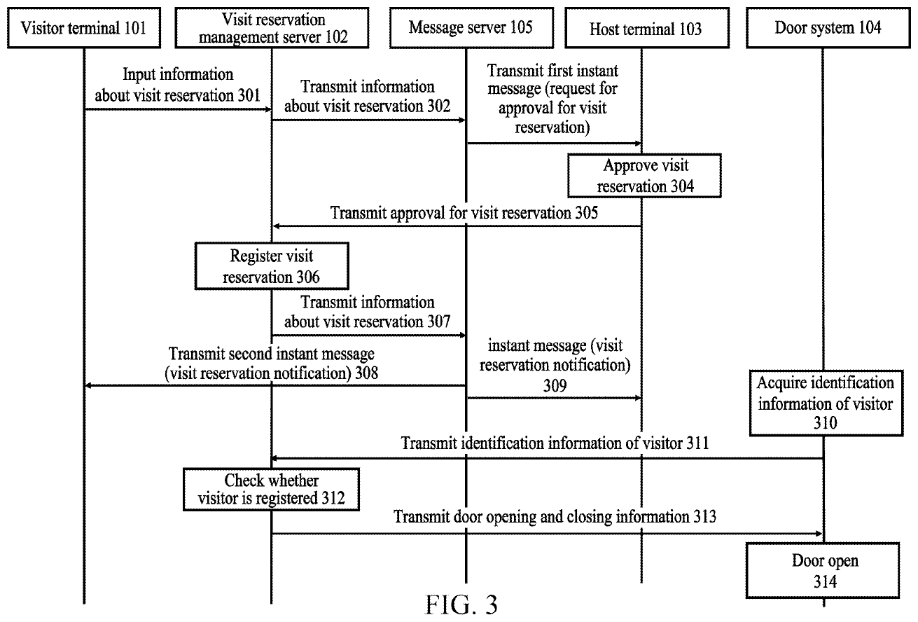

FIG. 2 illustrates a case in which the host terminal 103 having the right to approve the visit reservation makes the visit reservation. In this case, unlike FIG. 3, an approval process for the visit reservation is not required.

In operation 201, the host terminal 103 may input information about the visit reservation through a visit reservation registration page of the visit reservation management server 102.

In operation 202, the visit reservation management server 102 may register the visit reservation for the visitor terminal 101 based on information about the visit reservation. The information about the visit reservation input through the visit reservation registration page may include information about the visitor, information about the host, the visit place, and a visit schedule. In addition, the visit reservation management server 102 may generate the identification information of the visitor when registering the visit reservation.

In operation 203, the visit reservation management server 102 may transmit information about the visit reservation input by the visitor terminal 101 and the identification information of the visitor to the message server 105. Here, the identification information of the visitor may include the contact information of the visitor terminal 101 or the account registered by the visitor terminal 101 in the message server 105 or the visit reservation management server 102.

In operation 204, the message server 105 may transmit the first instant message to the visitor terminal 101 in order to notify whether the visit reservation is registered. In this case, the first instant message may include information about the visit reservation and the identification information of the visitor. Further, the first instant message may be transmitted to the visitor terminal 101 through the chat room of the channel of the institution or business to which the host of the host terminal 103 belongs, or the chat room of the channel of the visit reservation management server 102.

In operation 205, the message server 105 may transmit the second instant message to the host terminal 103 in order to notify whether the visit reservation is registered. In this case, the second instant message may be distinguished from the second instant message, and may include information about the visit reservation except for the identification information of the visitor. Further, the second instant message may be transmitted to the host terminal 103 through the chat room of the channel of the institution or business to which the host of the host terminal 103 belongs, or the chat room of the channel of the visit reservation management server 102.

In operation 206, the door system 104 may acquire the identification information of the visitor by recognizing the visitor terminal 101. For example, the visitor terminal 101 may display the first instant message received from the message server 105, and the door system 104 may recognize a code included in the first instant message. Then, the door system 104 may acquire the identification information of the visitor through the recognized code.

In operation 207, the door system 104 may transmit the identification information of the visitor to the visit reservation management server 102.

In operation 208, the visit reservation management server 102 may check whether the visitor is registered by using the identification information of the visitor received from the door system 102. For example, the visit reservation management server 102 may determine whether the identification information of the visitor received from the door system 104 corresponds to the visitor included in the visit reservation, thereby determining whether the visitor of the visitor terminal 101 recognized by the door system 104 is the registered user for the visit reservation. When the identification information of the visitor received from the door system 104 is the same as the visitor included in the visit reservation, it may be determined that the check-in of the visitor terminal 101 is successful.

In operation 209, the visit reservation management server 102 may transmit the door opening and closing information to the door system 104. In operation 312, when the visitor of the visitor terminal 101 recognized by the door system 104 is determined as the user registered for the visit reservation, the door opening and closing information may include a command to open the door.

In operation 210, when the command to open the door is included in the door opening and closing information, the door system 104 may open the door. Then, the visitor of the visitor terminal 101 may enter the visit place included in the visit reservation.

FIG. 3 is a flowchart illustrating a visit reservation management method of when the visitor terminal makes the visit reservation according to an example embodiment.

FIG. 3 illustrates a case in which the host terminal 103 approves the visit reservation when the visitor terminal 101 that does not have the authority to make the visit reservation makes the visit reservation.

In operation 301, the visitor terminal 101 may input information about the visit reservation through a visit reservation registration page of the visit reservation management server 102. The information about the visit reservation input through the visit reservation registration page may include information about the visitor, information about the host, the visit place, and a visit schedule.

In operation 302, the visit reservation management server 102 may transmit information about the visit reservation to the message server 105.

In operation 303, the message server 105 may transmit the first instant message including information about the visit reservation to the host terminal 103. In this case, the first instant message is a message for requesting the host terminal 103 to approve the visit reservation input by the visitor terminal 101.

In operation 304, the host terminal 103 may approve the visit reservation input by the visitor terminal 101 based on the first instant message including information about the visit reservation.

In operation 305, the host terminal 103 may transmit an approval for the visit reservation input by the visitor terminal 101 to the visit reservation management server 102.

In operation 306, the visit reservation management server 102 may register the visit reservation for the visitor terminal 101 based on information about the visit reservation. In addition, the visit reservation management server 102 may generate the identification information of the visitor when registering the visit reservation.

In operation 307, the visit reservation management server 102 may transmit information about the visit reservation input by the visitor terminal 101 and the identification information of the visitor to the message server 105.

In operation 308, the message server 105 may transmit the second instant message to the visitor terminal 101 in order to notify whether the visit reservation is registered. In this case, the second instant message may include information about the visit reservation and the identification information of the visitor. Further, the second instant message may be transmitted to the visitor terminal 101 through the chat room of the channel of the institution or business to which the host of the host terminal 103 belongs, or the chat room of the channel of the visit reservation management server 102.

In operation 309, the message server 105 may transmit the third instant message to the host terminal 103 in order to notify whether the visit reservation is registered. In this case, the third instant message may be distinguished from the third instant message, and may include information about the visit reservation except for the identification information of the visitor. Further, the third instant message may be transmitted to the host terminal 103 through the chat room of the channel of the institution or business to which the host of the host terminal 103 belongs, or the chat room of the channel of the visit reservation management server 102.

In operation 310, the door system 104 may acquire the identification information of the visitor by recognizing the visitor terminal 101. For example, the visitor terminal 101 may display the second instant message received from the message server 105, and the door system 104 may recognize a code included in the second instant message. Then, the door system 104 may acquire the identification information of the visitor through the recognized code.

In operation 311, the door system 104 may transmit the identification information of the visitor to the visit reservation management server 102.

In operation 312, the visit reservation management server 102 may check whether the visitor is registered by using the identification information of the visitor received from the door system 102. For example, the visit reservation management server 102 may determine whether the identification information of the visitor received from the door system 104 corresponds to the visitor included in the visit reservation, thereby determining whether the visitor of the visitor terminal 101 recognized by the door system 104 is the registered user for the visit reservation.

In operation 313, the visit reservation management server 102 may transmit the door opening and closing information to the door system 104. In operation 312, when the visitor of the visitor terminal 101 recognized by the door system 104 is determined as the user registered for the visit reservation, the door opening and closing information may include a command to open the door.

In operation 314, when the command to open the door is included in the door opening and closing information, the door system 104 may open the door. Then, the visitor of the visitor terminal 101 may enter the visit place included in the visit reservation.

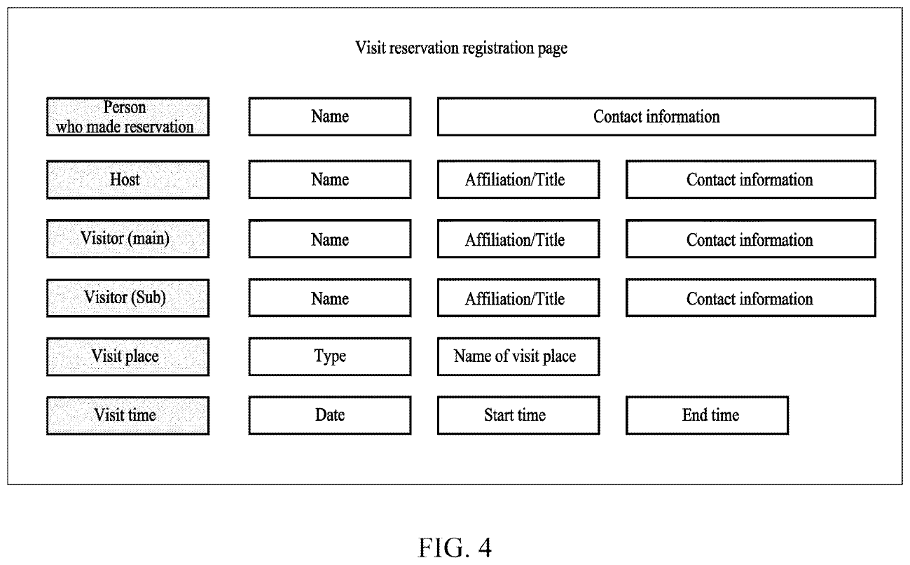

FIG. 4 is a diagram illustrating an example of a visit reservation registration page according to an example embodiment.

Referring to FIG. 4, FIG. 4 is a diagram illustrating an example of registering the visit reservation through the visit reservation registration page. Either the visitor terminal 101 or the host terminal 103 may register the visit reservation by inputting information about the visit reservation in the visit reservation registration page. When the visitor terminal 101 that does not have the authority for the visit reservation makes the visit reservation, an approval process for the visit reservation is performed. Approval for the visit reservation may be processed by the host terminal 103.

Information about the visit reservation entered through the visit reservation registration page may include information of a person who made a reservation (name, contact information), information of the host (name, affiliation/title or contact information), information of the visitor (name, affiliation/title or contact information), visit place (type (e.g., conference room, office), location information), and visit time (date, start time/end time). The matters described in FIG. 4 are merely examples, and may be added or changed according to example embodiments.

When there is one visitor, the visitor may be described as a main visitor, but when there are two or more visitors, the visitor may be divided into a main visitor and a sub-visitor. In this case, the identification information required to check-in at the visit place may be included in the instant message transmitted to the main visitor, or may be included in the instant message transmitted to the main visitor and the sub-visitor. In this case, the instant message transmitted to the main visitor or sub-visitor may include a code for acquiring identification information of the main visitor or sub-visitor. In addition, in order for the sub-visitor to enter the visit place, identification information of the main visitor may be required to be recognized by the door system 104. When it is determined that the main visitor may enter the visit place through the identification information of the main visitor, a determination process as to whether the sub-visitor is registered for the visit reservation may proceed using the identification information of the sub-visitor.

Further, when the visitor of the visitor terminal 101 registers the visit reservation, the visit reservation management server 102 may request the host terminal 103 to add a visit schedule and a visit time for registration of the visit reservation if the information for specifying the host of the host terminal 103 (e.g., name of the host, affiliation/title of the host, and contact information) is input.

In addition, the visit reservation management server 102 may set additional information related to the visit reservation with respect to the visit reservation. Additional information may include visit information provided to the visitor terminal 101 by default when making the visit reservation (e.g., at least one of a movement path of the visitor, a parking method of the visitor, a entry method of the visitor, and a waiting area of the visitor). Additional information for the visit reservation may be included in the instant message transmitted to the visitor terminal 101 after the visit reservation is registered.

In addition, when the visitor of the visitor terminal 101 visits the visit place temporarily or periodically at weekly/monthly/every quarter/or regular intervals, the property of the visit reservation may be set on the visit reservation registration page (temporary/periodic). At this time, if the visit is periodic, the host, the visitor, and the visit place are fixed, and the visit time may be entered as a period that must be repeatedly reserved (e.g., at 2 p.m. every Monday, at 10 a.m. on the second Wednesday of every month).

The visit reservation registration page may be interlocked with a scheduling application installed in the visitor terminal 101 or the host terminal 103. For example, a visit schedule may be registered in the scheduling application installed in the visitor terminal 101 or the host terminal 103. In addition, when the visitor terminal 101 or the host terminal 103 transmits the visit schedule to the visit reservation management server 102 through functions such as exporting or sharing to the visit reservation registration page, the visit reservation corresponding to the visit schedule may be automatically registered on the visit reservation registration page.

When a visit reservation is registered through the visit reservation registration page, the visit reservation may be provided to the scheduling application of the visitor terminal 101 or the host terminal 103 through functions such as exporting or sharing the visit reservation on the visit reservation registration page. Then, the information about the visit reservation registered on the visit reservation registration page may be registered in the scheduling application, and the schedule may be automatically set.

Although not shown in FIG. 4, the visit reservation management server 102 may not select the visit place by the visitor terminal 101 or the host terminal 103 from text or a list, and may provide the interface through the visit reservation registration page to designate directly the visit place on a map or layout diagram including a divided area.

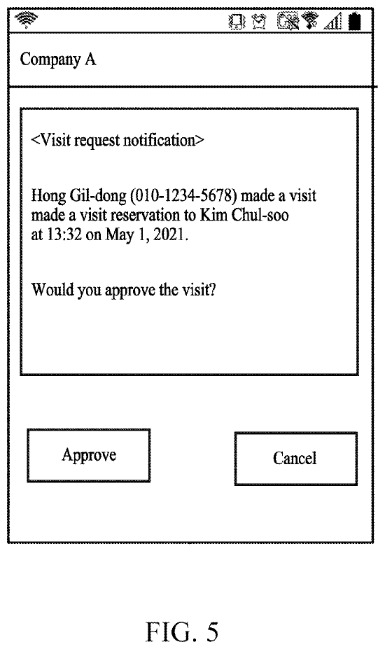

FIG. 5 is a diagram illustrating an example of the instant message for the host terminal to approve the visit reservation when the visitor terminal makes the visit reservation according to an example embodiment.

According to an example embodiment, the visitor terminal 101 or the host terminal 103 may register the visit reservation in the visit reservation management server 102. However, as described with reference to FIG. 3, the visitor terminal 101 does not have the authority for the visit reservation. The host of the host terminal 103 is a user pre-approved by the visit reservation management server 102, and has the authority to approve the visit reservation.

In this case, as shown in FIG. 5, when the visitor terminal 101 registers the visit reservation, the instant message including information about the visit reservation may be transmitted to the host terminal 103. Here, Kim Chul-soo means a visitor of the visitor terminal 101, and Hong Gil-dong means a host of the host terminal 103.

Therefore, when the host terminal 103 approves the visit reservation registered by the visitor terminal 101 through the instant message for the request for approval of the visit reservation shown in FIG. 5, the registration of the visit reservation input by the visitor terminal 101 is performed in the visit reservation management server 102.

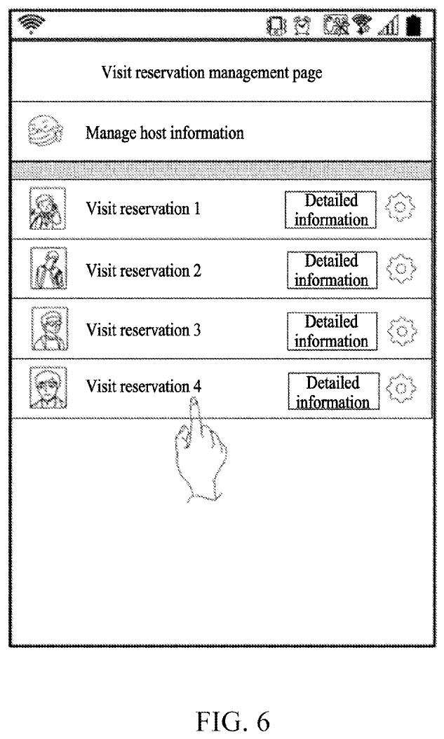

FIG. 6 is a diagram illustrating an example of a visit reservation management page according to an example embodiment.

After the visit reservation is registered through the visit reservation registration page of FIG. 4, the visitor terminal 101 or the host terminal 103 may access the visit reservation management page. FIG. 6 illustrates a process in which the host terminal 103 accesses the visit reservation management page.

The host terminal 103 may check a plurality of visit reservations registered through the visit reservation registration page on the visit reservation management page. The host terminal 103 may display information about the visit reservation input through the visit reservation registration page by selecting the detail information menu of each of the visit reservations on the visit reservation management page.

Further, when it is necessary to change or modify the visit reservation, the host terminal 103 may modify the information about the visit reservation input through the visit reservation registration page or cancel the visit reservation by selecting the management menu of the visit reservation management page.

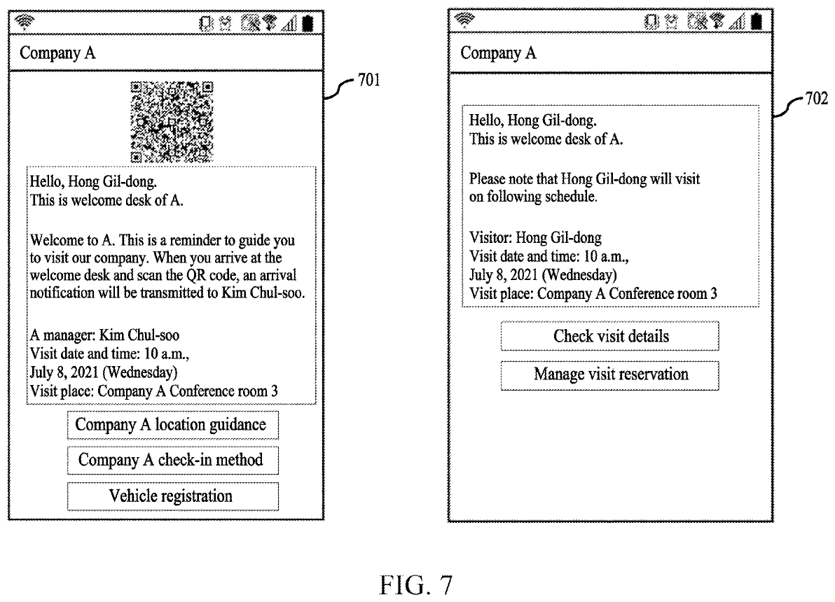

FIG. 7 is a diagram illustrating an example of an instant message provided to the visitor terminal and the host terminal after the visit reservation is registered according to an example embodiment.

Referring to FIG. 7, an instant message 701 transmitted by the visit reservation management server 102 to the visitor terminal 101 after the visit reservation is registered is illustrated. The instant message 701 is written according to a template set in the visit reservation management server 102, and may be automatically generated through the template associated with information about the visit reservation input in the visit reservation registration page.

The information about the visit reservation input in the visit reservation registration page may be set to correspond to a specific template including a phrase expressed in the instant message. As shown in FIG. 7, the instant message 701 including the host of the host terminal 103 (A manager—Kim Chul-soo), the visit date and time (10 a.m., Jul. 8, 2021 (Wednesday)), the visit place (company A conference room 3) may be transmitted to the visitor terminal 101.

The instant message 701 transmitted to the visitor terminal 101 may include the identification information of the visitor (e.g., QR code) for determining whether the visitor terminal 101 has a valid right to visit the visit place. The identification information is acquired from the visitor terminal 101 through the door system 104 when the visitor terminal 101 checks in at the visit place.

The visitor terminal 101 may display the code included in the instant message 701, and the door system 104 may recognize the code displayed on the visitor terminal 101. Then, the door system 104 may acquire the identification information of the visitor of the visitor terminal 101 through the recognized code. The visit reservation management server 102 may determine whether the visitor of the visitor terminal 101 recognized by the door system 104 is a user registered for the visit reservation using the identification information of the visitor. When the visitor of the visitor terminal 101 recognized by the door system 104 is a user registered for the visit reservation, the visit reservation management server 102 may transmit the door opening and closing information including a command instructing to open the door to the door system 104.

A message server 107 may transmit an instant message 701 to the visitor terminal 101 through a chat room of a channel of an institution or business to which the host of the host terminal 103 belongs, or a chat room of a channel of the visit reservation management server 102. The visit reservation management server 102 may request the message server 107 to transmit the instant message 701 to the visitor terminal 101 through the chat room of the channel of the institution or business to which the host of the host terminal 103 belongs, or the chat room of the channel of the visit reservation management server 102.

The instant message 701 may include additional information such as location guidance of the visit place (company A), a check-in method, and vehicle registration. The additional information may include information required before the visitor terminal 101 visits the visit place, and the present disclosure is not limited to the information shown in FIG. 7.

Referring to FIG. 7, an instant message 702 transmitted by the visit reservation management server 102 to the host terminal 103 after the visit reservation is registered is illustrated. The instant message 702 transmitted to the host terminal 103 does not include a code for acquiring the identification information of the visitor included in the instant message 701 transmitted to the visitor terminal 101.

In addition, the instant message 702 may include a visit detail check menu for checking information registered at the time of the visit reservation, and a visit reservation management menu for changing information about the visit reservation or canceling the visit reservation.

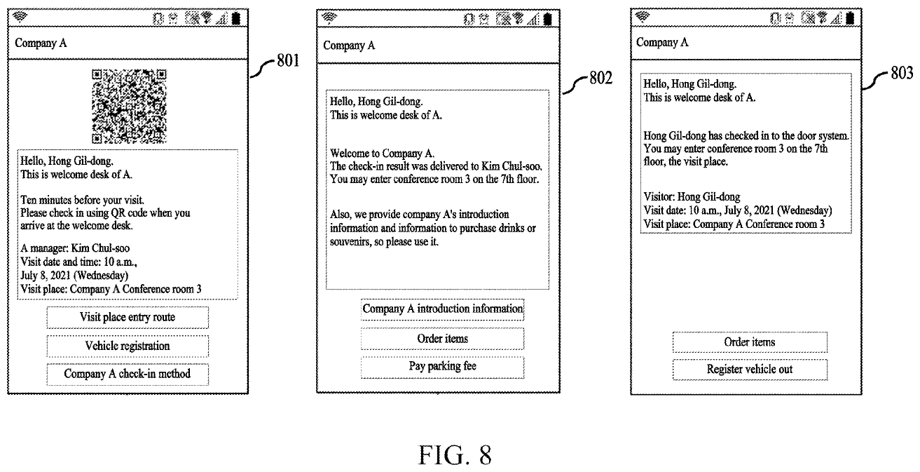

FIG. 8 is a diagram illustrating an example of an instant message provided to the visitor terminal and the host terminal of before and at the time the visitor terminal arrives at the visit place after the visit reservation, and after the visitor terminal checks in according to an example embodiment.

The visitor terminal 101 checks in at the visit place after the visit reservation is registered through the message server 105, the visit reservation management server 102 may transmit the instant message by the end time set in the visit reservation to the visitor terminal 101 after the visitor terminal 101 checks in. At this time, the instant message may be transmitted to the visitor terminal 101 or the host terminal 103 through the chat room of the channel of the institution or business to which the host of the host terminal 103 belongs, or the chat room of the channel of the visit reservation management server 102.

After the visit reservation is registered, the visit reservation management server 102 may transmit an instant message 801 for notifying the registration of the visit reservation to the visitor terminal 101 through the message server 105. In addition, the code displayed in the instant message 801 for notifying the registration of the visit reservation may be recognized by the door system 104 and connected with the identification information of the visitor for determining the success or failure of check-in of the visitor terminal 101.

The instant message 801 for notifying the registration of the visit reservation may include at least one of a menu for guiding an entry route to the visit place so that the visitor of the visitor terminal 101 may easily enter the visit place before the visitor terminal 101 visits the visit place, a menu for registering a vehicle in advance when the visitor enters the visit place by vehicle, or a menu for guiding a check-in method.

Before the visitor terminal 101 checks in to the visit place after the visit reservation is registered, the visit reservation management server 102 may transmit the instant message 801 for reminding the visit reservation through the message server 105 to the visitor terminal 101. The message content of the instant message 801 for reminding the visit reservation may include information about the visit reservation. In addition, the code displayed in the instant message 801 for reminding the registration of the visit reservation may be recognized by the door system 104 and connected with the identification information of the visitor for determining the success or failure of check-in of the visitor terminal 101. For example, the instant message 801 may include identification information of the visitor for the check-in of the visitor terminal 101. Here, the identification information may be acquired by recognizing the code displayed in the instant message of the visitor terminal 101 by the door system 104.

When the visitor terminal 101 checks in to the door system 104 disposed at the visit place, the visit reservation management server 102 may transmit the instant message including information on the result of success or failure of the check-in to the visitor terminal 101 through the message server 105. As described above, the check-in of the visitor terminal 101 may be determined as the success or failure of the check-in by comparing the identification information of the visitor acquired from the code with the identification information of the visitor included in the visit reservation after recognizing the code displayed in the visitor terminal 101 by the door system 104 disposed at the area related to the visit place of the visit reservation.

When the visitor terminal 101 successfully checks in to the visit place, the visit reservation management server 102 may transmit an instant message 802 for notifying the successful check-in to the visitor terminal 101 through the message server 105. In this case, when the visitor terminal 101 checks in to the door system 104 disposed at the visit place, the visit reservation management server 102 may transmit the instant message 802 related to the result of the check-in including the result information about the check-in to the visitor terminal 101 through the message server 105.

The instant message 802 transmitted to the visitor terminal 101 after the visitor terminal 101 checks in at the visit place may further include additional information related to the visit place in addition to information about the visit reservation. The instant message 802 may include at least one of a menu for guiding introduction information related to the visit place, a menu for providing information about items sold at the visit place (e.g., drinks, souvenirs, meals) and ordering items, a menu for cost settlement to get out of the vehicle of the visitor registered before an end point in time set in the visit reservation, or promotional content of the business entity corresponding to the visit place (e.g., coupons, event information, purchase information).

When the check-in of the visitor terminal 101 is successful, the visit reservation management server 102 provides various application services that can be provided in relation to the visit place through the instant message 802 delivered to the visitor terminal 101 after check-in. The application service may be provided through an application server connected to the visit reservation management server.

For the application service provided to the visitor terminal 101 in relation to the visit place, the visit reservation management server 102 may be connected to a plurality of application servers that provide the application service. Then, the visit reservation management server 102 may determine the application service to be provided to the visitor terminal 101, or determine the content provided by the application service based on the information about the visitor of the visitor terminal 101 or the information about the host of the host terminal 103. The visitor terminal 101 may acquire information about the application service related to the visit place through the application server connected to the visit reservation management server 102 through the instant message 802, and proceed with the application service.

As an example, the application may include at least one of a service for providing an introduction of an institution or business related to the visit place, a service for providing information about items sold at the visit place (e.g., drinks, souvenirs, meals) and ordering items, a service processing cost settlement to get out of the vehicle of the visitor registered before the end point in time set in the visit reservation, or a service providing promotional content of the institution or business related to the visit place (e.g., coupons, event information, purchase information, advertisement).

Before the end time set in the visit reservation, the visit reservation management server 102 may transmit the instant message 802 for notifying the end of the visit reservation to the visitor terminal 101 through the message server 105.

Further, after the visitor terminal 101 checks in to the visit place, the visit reservation management server 102 may transmit an instant message 803 including the notification for check-in to the host terminal 103 through the message server 105. As an example, the fifth instant message 803 may include at least one of a menu for providing information about items sold at the visit place (e.g., drinks, souvenirs, meals, etc.) and ordering items, or a menu for cost settlement to get out of the vehicle of the visitor registered before the end point in time set in the visit reservation.

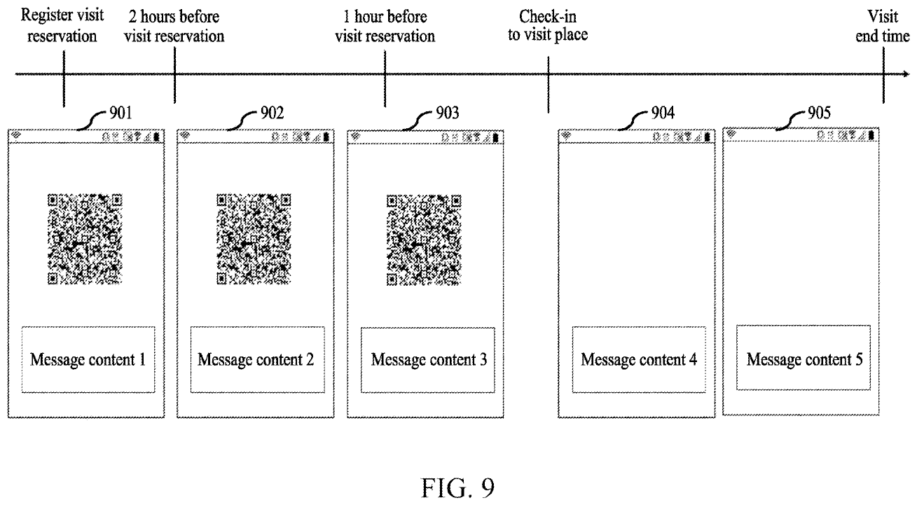

FIG. 9 is a diagram illustrating an instant message provided to a visitor terminal before and after check-in at a visit place according to an example embodiment.

Referring to FIG. 9, the visitor terminal 101 checks in at the visit place after the visit reservation is registered, and instant messages 901 to 905 transmitted to the visitor terminal 101 after the visitor terminal 101 checks in until the end time set in the visit reservation is illustrated. The instant message described in FIG. 9 may be transmitted by the visit reservation management server 102 to the visitor terminal 101 or the host terminal 103 through the message server 105. At this time, the instant message may be transmitted to the visitor terminal 101 or the host terminal 103 through the chat room of the channel of the institution or business to which the host of the host terminal 103 belongs, or the chat room of the channel of the visit reservation management server 102.

Message content included in the instant message for reminding the visitor terminal 101 of the visit reservation may be set differently according to a point in time close to the visit time set in the visit reservation.

After the visit reservation is registered as shown in the instant message 901 shown in FIG. 9, the visit reservation management server 102 may transmit the instant message 901 for notifying the registration of the visit reservation to the visitor terminal 101 through the message server 105. Message content 1 of the instant message 901 may include information about the visit reservation. In addition, the code displayed in the instant message 901 may be recognized by the door system 104 and connected with the identification information of the visitor for determining the success or failure of check-in of the visitor terminal 101.

The instant message 901 may include at least one of a menu for guiding the entry route to the visit place so that the visitor of the visitor terminal 101 may easily enter the visit place before the visitor terminal 101 visits the visit place, a menu for registering a vehicle in advance when the visitor enters the visit place by vehicle, or a menu for guiding a check-in method.

As in the instant message 801 shown in FIG. 8, before the visitor terminal 101 checks in to the visit place after the visit reservation is registered, the visit reservation management server 102 may transmit instant messages 902 and 903 for reminding the visit reservation through the message server 105 to the visitor terminal 101. Message content 2 of the instant message 902 and message content 3 of the instant message 903 may include information about the visit reservation. In addition, the code displayed in the instant message 902 and the instant message 903 may be recognized by the door system 104 and connected with the identification information of the visitor for determining the success or failure of check-in of the visitor terminal 101.

As in the instant message 802 shown in FIG. 8, when the visitor terminal 101 successfully checks in to the visit place, the visit reservation management server 102 may transmit an instant message 904 for notifying the successful check-in to the visitor terminal 101 through the message server 105. Message content 4 may include information about the visit reservation. In this case, when the visitor terminal 101 checks in to the door system 104 disposed at the visit place, the visit reservation management server 102 may transmit the instant message 904 including the result information about the check-in to the visitor terminal 101 through the message server 105.

When the check-in of the visitor terminal 101 is successful, the visit reservation management server 102 provides various application services that can be provided in relation to the visit place through the instant message delivered to the visitor terminal 101 after check-in. The application service may be provided through an application server connected to the visit reservation management server.

For the application service provided to the visitor terminal 101 in relation to the visit place, the visit reservation management server 102 may be connected to a plurality of application servers that provide the application service. Then, the visit reservation management server 102 may determine the application service to be provided to the visitor terminal 101, or determine the content provided by the application service based on the information about the visitor of the visitor terminal 101 or the information about the host of the host terminal 103. The visitor terminal 101 may acquire information about the application service related to the visit place through the application server connected to the visit reservation management server 102 through the instant message, and proceed with the application service.

As an example, the application service may include at least one of a service for providing an introduction of an institution or business related to the visit place, a service for providing information about items sold at the visit place (e.g., drinks, souvenirs, meals, etc.) and ordering items, a service processing cost settlement to get out of the vehicle of the visitor registered before the end point in time set in the visit reservation, or a service providing promotional content of the institution or business related to the visit place (e.g., coupons, event information, purchase information, advertisement, etc.). The visit reservation management server 102 may provide recommended content (e.g., advertisement) to the visitor terminal 101 according to the information about the visitor or the information about the host through the application service.

The instant message 905 may be a message transmitted by the visit reservation management server 102 to the visitor terminal 101 through the message server 105 before the end time set in the visit reservation. The instant message 905 may include the end time set in the visit reservation.

In FIG. 9, the instant message 902 for reminding the visitor terminal 101 of the visit reservation and the message content included in the instant message 903 may be set differently depending on a time point close to the visit time set in the visit reservation.

For example, when the visit time for the visit reservation is set at 10 a.m., the visit reservation management server 102 may transmit an instant message including a reminder for the visit reservation at 9 a.m. through the message server 105 to the visitor terminal 101. At this time, the instant message sent for the reminder at 9 a.m. includes information related to the visit reservation (visit place, visit time), and the instant message transmitted for the reminder at 9:40 a.m. close to the visit time may include information related to the visit reservation and detail information related to the visit place (e.g., at least one of parking information, waiting room information, corona preparation information, or pre-registration information).

The instant message 902 and the instant message 903 for reminding the visit reservation may be transmitted sequentially to the visitor terminal 101 according to a predetermined time interval until the visitor terminal 101 checks in before the visit time set in the visit reservation. The instant message subsequently provided to the visitor terminal 101 may be provided differently depending on whether the visitor terminal 101 responds to the instant message 902 and the instant message 903 for the reminder of the visit reservation. When the visitor terminal 101 responds to the instant message 902 and the instant message 903, the message content including a guidance of the visit place or introduction of the institution or business related to the visit place is included in preparation for the visit of the visitor terminal 101, and when the visitor terminal 101 does not respond to the instant message 902 and the instant message 903, the message content for notifying whether the visit reservation exists through information about the visit reservation may be included.

When the visitor terminal 101 repeatedly visits the same visit place at the visit time set in the visit reservation, the visit reservation management server 102 may interlocks with the identification information of the visitor terminal 101 or the host terminal 103 and store information about the visit reservation. When the visitor terminal 101 makes a subsequent visit reservation, information about the visit reservation input during the visit reservation previously input (e.g., at least one of the visit place, vehicle registration information of the visitor, and the visit time) may be recycled.

Then, the visit reservation management server 102 may transmit instant messages 901 to 905 for a notification of the visit reservation, a reminder of the visit reservation, the result of check-in of the visit place, and a notification of the end time of the visit reservation to the visitor terminal 101 according to the order of time in the chat room of the channel of the institution or business to which the host of the host terminal 103 belongs, or in the chat room of the channel of the visit reservation management server 102. After the end time included in the visit reservation has elapsed, the instant message for the notification of the visit reservation transmitted through the chat room, the reminder of the visit reservation, the result of check-in of the visit place, and the notification of the end time of the visit reservation may be deleted en bloc.

Alternatively, the instant message for the notification of the visit reservation transmitted through the chat room, the reminder of the visit reservation, the result of check-in of the visit place, and the notification of the end time of the visit reservation are stored in the visit reservation management server 102 by grouping into a visit reservation unit for each of the plurality of visit reservations on the visitor terminal 101 or the host terminal 103, and the interface for checking the instant message by specifying the visit reservation may also be provided.

Further, when the end time set for the visit reservation has elapsed after check-in for the visit place, contact information or business cards of each of the visitor of the visitor terminal 101 and the host of the host terminal 103 may be automatically shared between the visitor terminal 101 and the host terminal 103 set as the visit reservation after the end point in time of the visit reservation. As an example, the contact information or business cards of each of the visitor of the visitor terminal 101 and the host of the host terminal 103 may be shared through the instant message transmitted to the visitor terminal 101 or the instant message transmitted to the host terminal 103 when checking in to the visit place.

When the check-in for the visit place is in progress, the door system 104 may acquire the identification information of the visitor. When the door system 104 acquires the identification information of the visitor of the visitor terminal 101 through the instant message transmitted to the visitor terminal 101, the fact of the check-in of the visitor terminal 101 for the visit place and the identification information for a specific purpose (e.g., preparation for infectious disease) may be interlocked to each other and transmitted to the visit reservation management server 102.

Then, after checking in at the visit place, the content to be shared between the visitor of the visitor terminal 101 and the host of the host terminal 103 may be stored in the cloud managed by the visit reservation management server 102 or the message server 105. The content stored in the cloud format may be accessible through the instant message transmitted to the visitor terminal 101 or the instant message transmitted to the host terminal 103.

In addition, it is possible to access to the content through a storage space corresponding to the visit reservation identified by the instant message transmitted to the visitor terminal 101 or the instant message transmitted to the host terminal 103 in which a virtual storage space is set for each visit reservation.

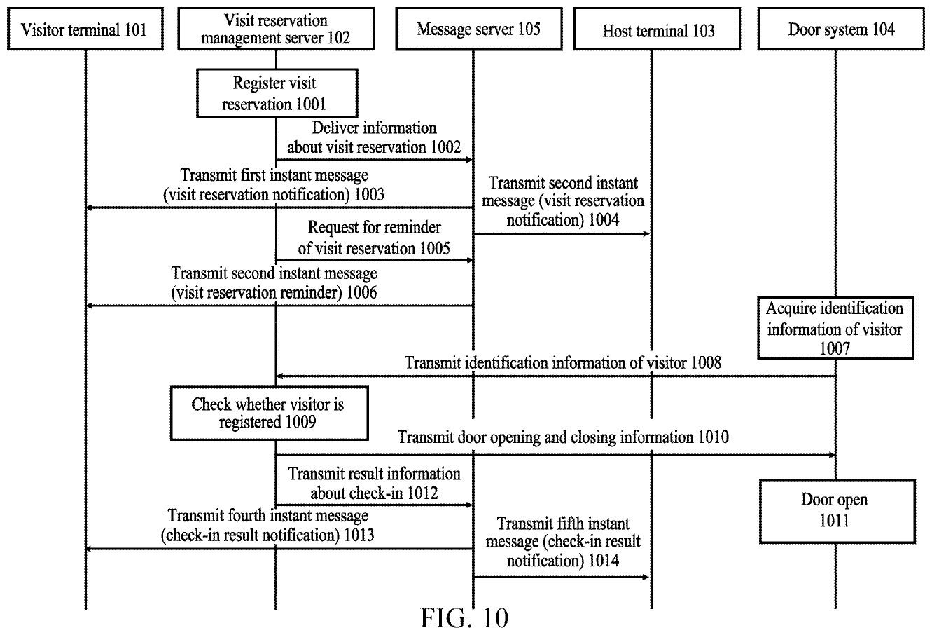

FIG. 10 is a diagram illustrating the visit reservation processing method according to an example embodiment.

According to an example embodiment, the visit reservation management server 102 may transmit the instant message for notifying that the visit reservation has been registered, the instant message for reminding of the visit reservation, the instant message for notifying the result of check-in of the visit place and the notification of the end time of the visit reservation to the visitor terminal 101 or the host terminal 103 through the message server 105. Here, the instant messages may be provided to the visitor terminal 101 according to the order of time in the chat room of the channel of the institution or business to which the host of the host terminal 103 belongs, or in the chat room of the channel of the visit reservation management server 102. Hereinafter, details of transmitting the above instant messages will be described in detail.

In operation 1001, the visit reservation management server 102 may register the visit reservation of the visitor terminal 101.

Although not shown in FIG. 2, registration of the visit reservation may be performed to through the following two processes. The first is a case in which the host terminal 103 having the right to approve the visit reservation makes the visit reservation. And, the second is a case in which the visitor terminal 101 which does not having the right to make the visit reservation makes the visit reservation.

When the host terminal 103 makes the visit reservation, a separate approval process is not performed. In other words, since the host terminal 103 registered and approved in advance in the visit reservation management server 102 makes the visit reservation, an approval process for the visit reservation is not required. However, when the visitor terminal 101 makes the visit reservation, since the visitor terminal 101 does not have the authority for the visit reservation, an approval process for the visit reservation is required.

When the visitor terminal 101 makes the visit reservation, the visit reservation management server 102 may transmit information about the visit reservation input by the visitor terminal 101 to the message server 105. Then, the message server 105 may transmit the instant message including information about the visit reservation to the host terminal 103. When the host terminal 103 approves the visit reservation based on the information about the visit reservation input by the visitor terminal 101, the visit reservation management server 102 may register the visit reservation processed through the visitor terminal 101.

In FIG. 10, the information about the visit reservation input through the visit reservation registration page of the visit reservation management server 102 may include information about the visitor, information about the host, the visit place, and the visit schedule. When the visit reservation is registered, the visit reservation management server 102 may generate identification information of the visitor related to the visit reservation after registering the visit reservation. Here, the identification information of the visitor may include contact information of the visitor or an account of the visitor related to the visit reservation management server 102 or the message server 105.

In operation 1002, the visit reservation management server 102 may deliver information about the visit reservation to the message server 105.

In operation 1003, the message server 105 may transmit a first instant message including information about the visit reservation and the identification information of the visitor to the visitor terminal 101. The first instant message may be a message notifying the visitor terminal 101 that the visit reservation has been registered. The first instant message may be transmitted to the visitor terminal 101 through the chat room of the channel of the institution or business to which the host of the host terminal 103 belongs, or the chat room of the channel of the visit reservation management server 102.

In operation 1004, the message server 105 may transmit the second instant message including information about the visit reservation to the host terminal 103. The second instant message may be transmitted to the visitor terminal 101 through the chat room of the channel of the institution or business to which the host of the host terminal 103 belongs, or the chat room of the channel of the visit reservation management server 102.

In operation 1005, the visit reservation management server 102 may transmit request for reminder of the visit reservation to the message server 105.

In operation 1006, the message server 105 may transmit the third instant message for the reminder about the visit reservation to the visitor terminal 101. The third instant message including the reminder for the visit reservation may include information about the visit reservation. The third instant message may be transmitted to the visitor terminal 101 through the chat room of the channel of the institution or business to which the host of the host terminal 103 belongs, or the chat room of the channel of the visit reservation management server 102. The message server 105 may repeatedly transmit the third instant message to the visitor terminal 101 for a predetermined time interval until before the visit time included in the visit reservation.

In operation 1007, the door system 104 may acquire the identification information of the visitor by recognizing the visitor terminal 101. For example, the visitor terminal 101 may display the first instant message received from the message server 105, and the door system 104 may recognize a code included in the first instant message. Then, the door system 104 may acquire the identification information of the visitor through the recognized code. The door system 104 may be installed at the visit place related to the visit reservation, and may acquire the identification information of the visitor by recognizing the code included in the first instant message.

In operation 1008, the door system 104 may transmit the identification information of the visitor acquired by recognizing the visitor terminal 101 to the visit reservation management server 102.

In operation 1009, the visit reservation management server 102 may check whether the visitor is registered by using the identification information of the visitor received from the door system 102. For example, the visit reservation management server 102 may determine whether the identification information of the visitor received from the door system 104 corresponds to the visitor included in the visit reservation, thereby determining whether the visitor of the visitor terminal 101 recognized by the door system 104 is the registered user for the visit reservation.

In operation 1010, the visit reservation management server 102 may transmit the door opening and closing information to the door system 104. In operation 1010, when the visitor of the visitor terminal 101 recognized based on the identification information of the visitor acquired from the visitor terminal 101 is determined as the user registered for the visit reservation, the door opening and closing information may include a command to open the door.

In operation 1011, when the command to open the door is included in the door opening and closing information, the door system 104 may open the door. Then, the visitor of the visitor terminal 101 may enter the visit place included in the visit reservation.

In operation 1012, the visit reservation management server 102 may transmit the result information about the check-in of the visitor terminal 101 to the message server 105. The result information about the check-in may be decided depending on whether the visitor of the visitor terminal 101 recognized by the door system 104 based on the identification information of the visitor acquired from the visitor terminal 101 is the same as the visitor registered in the visit reservation management server 102.

When the visitor of the visitor terminal 101 who has checked in the door system 104 through the identification information of the visitor received from the visitor terminal 101 by recognizing the visitor terminal 101 by the door system 104 is the same as the visitor included in the visit reservation, it may be determined that the check-in of the visitor terminal 101 is successful.

In operation 1013, the message server 105 may transmit the fourth instant message including the result information (success or failure) about the check-in of the visitor terminal 101 to the visitor terminal 101. The fourth instant message may be transmitted to the visitor terminal 101 through the chat room of the channel of the institution or business to which the host of the host terminal 103 belongs, or the chat room of the channel of the visit reservation management server 102.

In operation 1014, the message server 105 may transmit a fifth instant message including the result information (success or failure) about the check-in of the visitor terminal 101 to the visitor terminal 101. The fifth instant message may be transmitted to the host terminal 103 through the chat room of the channel of the institution or business to which the host of the host terminal 103 belongs, or the chat room of the channel of the visit reservation management server 102.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or deliver data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to acquire a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

### EXPLANATION OF REFERENCE NUMERALS

101: Visitor terminal
102: Visit reservation management server
103: Host terminal
104: Door system

What is claimed is:

1. A visit reservation management method performed by a visit reservation management server, comprising:
receiving information about a visit reservation from a host terminal;
registering the visit reservation based on the information about the visit reservation received from the host terminal;
issuing identification information for a visitor of a visitor terminal recognized by a door system;
transmitting a first instant message including information about the visit reservation and the identification information to the visitor terminal using a message server;
transmitting a second instant message including information about the visit reservation to the host terminal using the message server;
receiving the identification information of the visitor recognized by the door system from the door system;
checking whether the visitor of the visitor terminal is a visitor registered as the visit reservation by using the identification information of the visitor; and
transmitting door opening and closing information to the door system when the visitor is the visitor registered as the visit reservation,
wherein the first instant message and the second instant message are transmitted through a chat room of a channel of an institution or business to which a host of the host terminal belongs, or a chat room of a channel of the visit reservation management server.

2. The visit reservation management method of claim 1, wherein the host terminal has an authority to approve the visit reservation as a registered user pre-approved by the visit reservation management server.

3. The visit reservation management method of claim 1, wherein the identification information of the visitor includes contact information of the visitor terminal or an account registered by the visitor terminal in the message server or the visit reservation management server, and
the door system is configured to acquire the identification information of the visitor by recognizing a code displayed in the first instant message.

4. The visit reservation management method of claim 1, wherein, after a schedule is input to a scheduling application installed in the visitor terminal or the host terminal, the visit reservation corresponding to the schedule set in the scheduling application is registered, or
after the visit reservation is registered in the visit reservation management server, the registered visit reservation is provided to the scheduling application and the schedule corresponding to the visit reservation is set in the scheduling application.

5. A visit reservation management method performed by a visit reservation management server, comprising:
receiving information about a visit reservation from a visitor terminal;
transmitting a first instant message requesting approval for the visit reservation of the visitor terminal using the message server;
registering the visit reservation based on information about the visit reservation when receiving approval for the visit reservation of the visitor terminal from the host terminal;
issuing identification information for a visitor of the visitor terminal recognized by a door system;
transmitting a second instant message including information about the visit reservation and the identification information to the visitor terminal using the message server;
transmitting a third instant message including information about the visit reservation to the host terminal using the message server;
receiving the identification information of the visitor recognized by the door system from the door system;
checking whether the visitor of the visitor terminal is a visitor registered as the visit reservation by using the identification information of the visitor; and
transmitting door opening and closing information to the door system when the visitor is the visitor registered as the visit reservation,
wherein the first instant message, the second instant message, and the third instant message are transmitted through a chat room of a channel of an institution or business to which a host of the host terminal belongs, or a chat room of a channel of the visit reservation management server.

6. The visit reservation management method of claim 5, wherein the host terminal has an authority to approve the visit reservation as a registered user pre-approved by the visit reservation management server.

7. The visit reservation management method of claim 5, wherein the identification information of the visitor includes contact information of the visitor terminal or an account registered by the visitor terminal in the message server or the visit reservation management server, and
the door system is configured to acquire the identification information of the visitor by recognizing a code displayed in the second instant message.

8. A visit reservation processing method performed by a visit reservation management server, comprising:
after a visit reservation is registered, transmitting a first instant message including information about the visit reservation and identification information of a visitor to a visitor terminal using a message server;
transmitting a second instant message for reminding the visit reservation to the visitor terminal using the message server until before a visit time set in the visit reservation;
receiving, from a door system, the identification information of the visitor recognized by the door system;
checking whether the visitor of the visitor terminal is a visitor registered as the visit reservation by using the identification information of the visitor;
transmitting door opening and closing information to the door system when the visitor is the visitor registered as the visit reservation; and
transmitting a third instant message including result information about check-in of the visitor terminal for checking whether the visitor of the visitor terminal is a visitor registered as the visit reservation using the message server to the visitor terminal,
wherein the first instant message, the second instant message, and the third instant message are transmitted to the visitor terminal through a chat room of a channel of an institution or business to which a host of the host terminal belongs, or a chat room of a channel of the visit reservation management server.

9. The visit reservation processing method of claim 8, further comprising:
transmitting a fourth instant message for notifying an end of the visit reservation to the visitor terminal using the message server before an end time set in the visit reservation.

10. The visit reservation processing method of claim 9, wherein the visit reservation management server is configured to provide an application service related to a visit place set in the visit reservation to the visitor terminal through the first instant message, the second instant message, or the third instant message.

11. The visit reservation processing method of claim 10, wherein the application service is provided through an application server connected to the visit reservation management server, and comprises at least one of:
(i) a service for registering a vehicle of the visitor at the visit place; (ii) a service for providing an introduction of an institution or business related to the visit place; (iii) a service providing information about an item sold at the visit place and allowing to order the item; (iv) a service processing cost settlement to get out of the vehicle of the visitor registered before an end point in time set in the visit reservation, or (v) a service providing promotional content of the institution or business related to the visit place.

12. The visit reservation processing method of claim 10, wherein the third instant message comprises content to be reminded that is different according to a time interval with the visit time included in the visit reservation.

13. The visit reservation processing method of claim 8, further comprising:
providing an interface accessible to content to be shared between the visitor of the visitor terminal and the host of the host terminal before or after a visit end time included in the visit reservation.

14. The visit reservation processing method of claim 13, wherein the content is stored in a storage space set in the visit reservation management server for each of the visit reservation.

15. The visit reservation processing method of claim 8, further comprising:
providing an interface capable of checking an instant message for a notification of the visit reservation, the reminder of the visit reservation, a result of check-in at the visit place, or a notification of an end time of the visit reservation transmitted through the chat room.

16. A non-transitory computer-readable recording medium in which a program for executing the method of claim 1 is recorded.

17. A non-transitory computer-readable recording medium in which a program for executing the method of claim 5 is recorded.

18. A non-transitory computer-readable recording medium in which a program for executing the method of claim 8 is recorded.
